(19) United States
(12) Patent Application Publication
(10) Pub. No.: US 2024/0111678 A1
(43) Pub. Date: Apr. 4, 2024

(54) PUSHED PREFETCHING IN A MEMORY HIERARCHY

(71) Applicant: ADVANCED MICRO DEVICES, INC., Santa Clara, CA (US)

(72) Inventors: JAGADISH B. KOTRA, AUSTIN, TX (US); JOHN KALAMATIANOS, BOXBOROUGH, MA (US); PAUL MOYER, FORT COLLINS, CO (US); GABRIEL H. LOH, BELLEVUE, WA (US)

(21) Appl. No.: 17/958,120

(22) Filed: Sep. 30, 2022

(51) Int. Cl. G06F 12/0862; G06F 12/0811

(52) U.S. Cl. CPC G06F 12/0862; G06F 12/0811

(57) ABSTRACT

Systems and methods for pushed prefetching include: multiple core complexes, each core complex having multiple cores and multiple caches, the multiple caches configured in a memory hierarchy with multiple levels; an interconnect device coupling the core complexes to each other and coupling the core complexes to shared memory, the shared memory at a lower level of the memory hierarchy than the multiple caches; and a push-based prefetcher having logic to: monitor memory traffic between caches of a first level of the memory hierarchy and the shared memory; and based on the monitoring, initiate a prefetch of data to a cache of the first level of the memory hierarchy.

### BACKGROUND

Cache prefetching is a technique used by computer systems and processors to improve execution performance by fetching instructions or data from their original storage in slower memory to a faster local memory before it is actually needed. Hardware based prefetching can include a dedicated hardware mechanism, such as a prefetcher, in the processor that monitors the stream of instructions or data being requested by the executing program, recognizes the next few elements that the program might need based on this stream, and prefetches the data into the processor's cache.

### BRIEF DESCRIPTION OF THE DRAWINGS

FIG. 1 shows a block diagram of an example system including multiple core complexes and configured for pushed prefetching in accordance with implementations of the present disclosure.

FIG. 2 shows a block diagram of an example system including a single core complex and configured for pushed prefetching in accordance with implementations of the present disclosure.

FIG. 3 is a flowchart of an example method for pushed prefetch throttling according to some implementations of the present disclosure.

FIG. 4 is a flowchart of an example method for pushed prefetch throttling according to some implementations of the present disclosure.

FIG. 5 is a flowchart of an example method for pushed prefetch throttling according to some implementations of the present disclosure.

### DETAILED DESCRIPTION

Conventional methods of prefetching utilize a pull-based prefetcher for issuing prefetch requests, where the issued prefetch request is propagated down the memory hierarchy through each cache level to the memory level where the data resides, before prefetching the data all the way back up to the level where the request was issued. Such methods for prefetching can exhibit poor prefetcher timeliness and coverage.

The present specification sets forth various implementations of systems, apparatus, and methods for pushed prefetching in a memory hierarchy. The present specification describes a system and apparatus embodiments for pushed prefetching in a memory hierarchy that includes multiple core complexes, where each core complex includes multiple cores and multiple caches. The caches are configured in a memory hierarchy with multiple levels. An interconnect device coupling the core complexes to each other and coupling the core complexes to shared memory is also included. The shared memory is at a lower level of the memory hierarchy than the caches and each core complex includes a push-based prefetcher. In some implementations, the push-based prefetcher is separate from the plurality of core complexes. The push-based prefetcher comprises logic to monitor memory traffic between caches of a first or selected level of the memory hierarchy and the shared memory. Based on the monitoring, the push-based prefetcher initiates a prefetch of data to a cache of the first level of the memory hierarchy.

In some implementations, the caches of the first level are L3 caches of the core complexes. In some implementations, the push-based prefetcher further comprises logic to send a resource acquisition request to the cache of the first level of the memory hierarchy and receive an acknowledgement of resource acquisition including a tag based on the resource acquisition request. Additionally, the push-based prefetcher acquires data from a data source in the memory hierarchy and, only after receiving the acknowledgement, sends the acquired data and the tag to a data target in the cache of the first level of the memory hierarchy. In some implementations, sending the resource acquisition request occurs in parallel with acquiring the data from the data source.

In some implementations, the push-based prefetcher further comprises logic to send a resource acquisition request to the cache of the first level of the memory hierarchy and receive a negative-acknowledgement of resource acquisition, where the negative-acknowledgement includes a tag. In such implementations, the push-based prefetcher drops the prefetch only after receiving the negative-acknowledgement.

In some implementations, the push-based prefetcher further comprises logic to send a resource acquisition request to the cache of the first level of the memory hierarchy and acquire data from a data source in the memory hierarchy. Responsive to acquiring the data from the data source and if an acknowledgment of the resource acquisition request has been received including a tag, the push-based prefetcher sends the acquired data and the tag to a data target in the cache of the first level of the memory hierarchy. If an acknowledgement of the resource acquisition request has not been received, the push-based prefetcher drops the prefetch independent of receiving a negative-acknowledgement.

In some implementations, the push-based prefetcher further comprises logic to determine, from a memory directory for the data, that a source of the data is at a lower level than the cache of the first level and acquire the data from the source of the data. In some implementations, the push-based prefetcher further comprises logic to determine, from a memory directory for the data, that a source of the data is at any level within another core complex separate from the cache of the first level and acquire the data from the source of the data. In some implementations, the push-based prefetcher further comprises logic to determine, from a memory directory for the data, that the data is already at the cache of the first level and determine not to prefetch the data.

In some implementations, the system or apparatus for pushed prefetching in a memory hierarchy further includes a cache controller of the cache of the first level. The cache controller includes logic configured to throttle responses to resource acquisition requests sent from the push-based prefetcher based on prefetcher statistics. In some aspects, the cache controller sends a negative-acknowledgement to the push-based prefetcher based on the prefetcher statistics independent of availability of resources for the push-based prefetcher.

In some implementations, the system or apparatus for pushed prefetching in a memory hierarchy further includes a cache controller of the cache of the first level. The cache controller comprises logic configured to send, to the push-based prefetcher, throttling signals based on prefetcher statistics. The push-based prefetcher throttles the sending of resource acquisition requests based on the throttling signals.

The present specification also describes a method of pushed prefetching in a memory hierarchy that includes monitoring memory traffic between caches of a first level of a memory hierarchy and a second, lower level of a memory hierarchy. Such method also includes initiating a prefetch of data to a cache of the first level of the memory hierarchy based on the monitoring.

In some implementations, the caches of the first level are L2 caches in a core complex, and the second, lower level is a shared L3 cache in the core complex. In some implementations, the caches of the first level are L3 caches of multiple core complexes, and the second, lower level is memory shared by the core complexes.

In some implementations, the method further includes sending a resource acquisition request to the cache of the first level of the memory hierarchy and receiving, based on the resource acquisition request, an acknowledgement of resource acquisition including a tag. The method also includes acquiring data from a data source in the memory hierarchy and, only after receiving the acknowledgement, sending the acquired data and the tag to a data target in the cache of the first level of the memory hierarchy. In some implementations, sending the resource acquisition request occurs in parallel with acquiring the data from the data source.

In some implementations, the method also includes sending a resource acquisition request to the cache of the first level of the memory hierarchy and receiving, based on the resource acquisition request, a negative-acknowledgement of resource acquisition including a tag. The method also includes dropping the prefetch responsive to the negative-acknowledgement.

In some implementations, the method further includes sending a resource acquisition request to the cache of the first level of the memory hierarchy and acquiring data from a data source in the memory hierarchy. Responsive to acquiring the data from the data source and if an acknowledgment of the resource acquisition request has been received including a tag, the method includes sending the acquired data and the tag to a data target in the cache of the first level of the memory hierarchy. If an acknowledgement of the resource acquisition request has not been received, the method includes dropping the prefetch independent of receiving a negative-acknowledgement.

The present specification also describes an apparatus comprising multiple cores and multiple caches configured in a memory hierarchy with multiple levels, where the one or more of the caches is shared by the cores. The apparatus also includes a push-based prefetcher comprising logic to monitor memory traffic between caches of a first level of the memory hierarchy and a shared cache of a second, lower level of the memory hierarchy. The push-based prefetcher also initiates, based on the monitoring, a prefetch of data to a cache of the first level of the memory hierarchy.

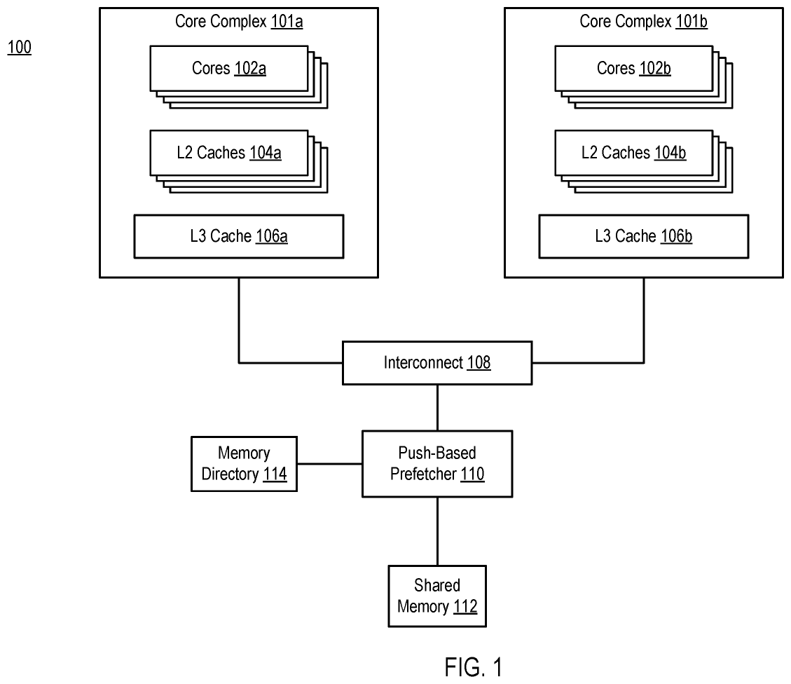

Pushed prefetching in accordance with the present disclosure is generally implemented with computers, that is, with computing systems. Implementations in accordance with the present disclosure may, in some conditions, result in computers that operate with greater speed and/or lower latency of processing—features which are highly desirable in many computing arrangements. Examples of computers that may implement embodiments of present disclosure include servers, laptops, portable devices (e.g., mobile phone, handheld game consoles, etc.), game consoles, embedded computing devices and the like. For further explanation, therefore, FIG. 1 sets forth a block diagram of a computing system including an exemplary system 100 configured for pushed prefetching according to implementations of the present disclosure. The example system 100 of FIG. 1 includes core complexes 101a and 101b, a push-based prefetcher 110, a memory directory 114, and shared memory 112 which is connected to the core complexes 101a and 101b through an interconnect 108. The example memory directory 114 is configured to monitor the memory traffic moving between the core complexes and is also configured to keep track of the data currently residing on each level of the memory hierarchy within each of the core complexes. In some implementations, the memory directory 114 of example system 100 is a cache probe filter directory.

The example processor core complexes 101a and 101b each include multiple processor cores (102a, 102b), multiple L2 caches (104a, 104b), and a shared L3 cache (106a, 106b, shared amongst the cores 102a, 102b of the respective core complex—e.g., L3 cache 106a is shared amongst cores 102a of core complex 101a). The example core complexes also include other computer components, hardware, software, firmware, and the like not shown here. For example, each of the cores within each core complex includes an L1 cache (not shown in FIG. 1). The example caches (L1 caches, L2 caches, and L3 caches) of FIG. 1 are configured in a memory hierarchy with multiple levels. In such a memory hierarchy, each type of cache is on a different memory level. For example, in the system 100 of FIG. 1, the L1 caches (not shown in FIG. 1) within the cores 102a and 102b are at a highest level of the memory hierarchy, the L2 caches 104a and 104b are at a next lower level of the memory hierarchy, the L3 caches of each core complex (106a, 106b) are at a next lower level of the memory hierarchy. Readers of skill will understand that the example core complexes of system 100 can include additional caches, at additional levels within the memory hierarchy, which are not shown in FIG. 1.

The example interconnect 108 of FIG. 1 is configured to couple the core complexes 101a and 101b to each other and is also configured to couple the core complexes 101a and 101b to shared memory 112. In some implementations, the shared memory 112 is at a level within the memory hierarchy that is lower than the levels of each of the caches within the core complexes. In some implementations, the shared memory 112 includes dynamic random access memory (DRAM) or other types of memory.

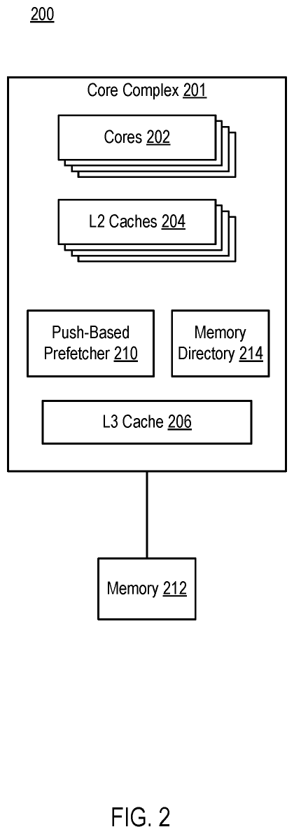

In the example system 100 of FIG. 1, the example push-based prefetcher 110 is separate from the core complexes. In system 100, push-based prefetcher 110 is in communication with interconnect 108, shared memory 112 and memory directory 114 and logically sits between these components. Further, through interconnect 108, push-based prefetcher 110 is in communication with core complexes 101a and 101b. In some implementations, the push-based prefetcher 110 is configured to monitor memory traffic between multiple caches of a first level of the memory hierarchy and a second, lower level of a memory hierarchy. In exemplary embodiments disclosed herein, the memory hierarchy includes various levels of cache and shared memory. As those skilled in the art will appreciate, other embodiments could include other aspects of memory in system 100 (e.g., non-volatile memory such as drives like SSDs or SATA drivers) and/or could be applied to only portions of the memory hierarchy of the system. Here, those skilled in the art will understand that the term ‘the first level’ of the memory hierarchy is not limited to L1 caches or to the highest level of the memory hierarchy but can be any one of the multiple levels of the memory hierarchy. The term “higher level” refers to a numerically lower level of the memory hierarchy (i.e., L2 cache is a higher level of cache memory than either L3 or L4 cache). Similarly, the term ‘a second, lower level’ of the memory hierarchy is not limited to L2 caches or to the second highest level of the memory hierarchy and “lower level” refers to a numerically higher memory level (e.g., L2 cache is a lower level than L1 cache). In the example system 100 of FIG. 1, the multiple caches of the ‘first level’ of the memory hierarchy are the L3 caches 106a and 106b of the multiple core complexes, and the ‘second, lower level’ of the memory hierarchy is the shared memory 112. In other implementations, the multiple caches of the ‘first level’ of the memory hierarchy are the L2 caches of a core complex and the ‘second, lower level’ of the memory hierarchy is an L3 cache of the core complex (see FIG. 2 for further explanation). In some implementations, monitoring memory traffic between multiple caches of a first level of the memory hierarchy and the shared memory 112 is carried out by the push-based prefetcher 110 monitoring, at the interconnect 108, memory traffic passing between each of core complex 101a, core complex 101b, and shared memory 112.

In some implementations, the push-based prefetcher 110 is also configured to initiate a prefetch of data to a cache of the first level of the memory hierarchy based on the monitoring of the memory traffic. In some implementations, initiating a prefetch to a cache of the first level of the memory hierarchy is carried out by the push-based prefetcher 110 requesting, in a prefetch request, to send data to the cache of the first level of the memory hierarchy. In some implementations, in the example system 100 of FIG. 1, the push-based prefetcher 110 can initiate a prefetch of data to be transmitted to an L3 cache of one of the core complexes based on monitoring traffic between the L3 caches and the shared memory. For example, in the system 100 of FIG. 1, the push-based prefetcher 110 can initiate a prefetch of data to the L3 cache 106a of core complex 101a based on monitoring traffic between the L3 caches and the shared memory 112. In some implementations, the prefetch request is sent through the interconnect 108 of the example system 100 to L3 cache 106a, 106b.

In some implementations, initiating a prefetch of data to a cache of the first level of the memory hierarchy includes sending a resource acquisition request to the cache. The resource acquisition request is sent by the push-based prefetcher to the cache of the first level and includes a request to send data to the cache. The push-based prefetcher, in initiating a prefetch of data to a cache of the first level of the memory hierarchy, can receive, based on the resource acquisition request, an acknowledgement of resource acquisition including a tag. The acknowledgement of resource acquisition is received by the push-based prefetcher from the cache in response to sending the resource acquisition request to the cache. In some implementations, the acknowledgement of resource acquisition is received from a cache controller (not shown in FIG. 1) of the cache. The tag included within the acknowledgement of resource acquisition includes an ID of a Miss Status Handling Register (MSHR) within an MSHR array, where the MSHR array keeps track of in-flight misses, and where each MSHR within the array refers to a missing cache line. In sending a tag with an acknowledgement to the push-based prefetcher, the cache indicates to the prefetcher that there are available resources within the cache for receiving the prefetch data, as well as identifying which MSHR the cache has allocated for the prefetch request. Continuing with the above example, in the system 100 of FIG. 1, the push-based prefetcher 110 initiates the prefetch of data to the L3 cache 106a by sending a resource acquisition request to the L3 cache 106a. In such an example, the push-based prefetcher 110 receives an acknowledgement of resource acquisition from the L3 cache 106a, the acknowledgement including a tag indicating a MSHR ID of a MSHR array included within the L3 cache 106a.

In some implementations, initiating, by the push-based prefetcher 110, a prefetch of data to a cache of the first level of the memory hierarchy also includes acquiring data from a data source in the memory hierarchy. Acquiring data from a data source in the memory hierarchy is carried out by the push-based prefetcher by determining which data source in the memory hierarchy from which to retrieve the data to prefetch for the cache of the first level, and subsequently retrieving such data from the determined data source and, ultimately, transmitting to the cache of the first level. Continuing with the above example, in the system 100 of FIG. 1, the push-based prefetcher 110 acquires data from the shared memory 112 by determining the data source from which to retrieve the data to prefetch as being the shared memory 112, and subsequently retrieving such data from the shared memory 112. In some implementations, acquiring the data from the data source occurs in parallel with sending the resource acquisition request.

In some implementations, acquiring data from a data source in the memory hierarchy includes referencing a memory directory 114. In the system 100 of FIG. 1, the example memory directory 114 is coupled to the interconnect 108 or to the push-based prefetcher 110. The example memory directory 114 is configured to monitor the memory traffic moving between the core complexes and is also configured to keep track of the data currently residing on each level of the memory hierarchy within each of the core complexes. In some implementations, the memory directory 114 of example system 100 is a cache probe filter directory.

In acquiring data from a data source in the memory hierarchy, the push-based prefetcher 110 can reference the memory directory 114 to determine the data source in the memory hierarchy that includes the data to be acquired. In some implementations, the data source is determined, by logic within the push-based prefetcher, to be within the shared memory 112, within another core complex, or within the cache of the first level of the memory hierarchy. If the data source is determined to be the cache of the first level, where the cache already has the data, the push-based prefetcher determines not to prefetch or determines to drop the prefetch. If the data source is determined to be the shared memory 112, or any other level of the memory hierarchy lower than the cache of the first level, the push-based prefetcher acquires the data from that data source. If the data source is determined to be, according to the memory directory 114, within a core complex other than the core complex of the cache of the first level, the push-based prefetcher acquires the data from that data source, independent of which level of the memory hierarchy the data source resides.

In some implementations, the push-based prefetcher 110, in prefetching data to a cache of the first level of the memory hierarchy, is configured to send the acquired data and the tag to a data target in the cache of the first level of the memory hierarchy. Sending the acquired data and the tag to a data target in the cache of the first level of the memory hierarchy is carried out by the push-based prefetcher 110 transmitting a resource acquisition request (a request by prefetcher 110 to send data to the cache of the first level of the memory hierarchy.) Only after prefetcher 110 receives an acknowledgement from the cache (or logic related to the cache—e.g., a cache controller) to the resource acquisition request, since the cache must first allocate resources (a specific MSHR) for receiving the prefetch data from the push-based prefetcher, does prefetcher 110 transmit the acquired data and tag to the data target in the cache. Accordingly, and continuing with the above example, in the system 100 of FIG. 1, the push-based prefetcher 110, only after receiving an acknowledgement including a tag from the L3 cache 106a, sends the acquired data and the received tag to a data target in the L3 cache 106a, thereby completing the prefetch of data to the cache of the first level of the memory hierarchy.

In some implementations, in initiating a prefetch of data to a cache of the first level of the memory hierarchy, the push-based prefetcher 110 can receive, based on a resource acquisition request, a negative-acknowledgement of resource acquisition. The negative-acknowledgement of resource acquisition is received by the push-based prefetcher from the cache in response to sending the resource acquisition request to the cache. In some implementations, the negative-acknowledgement of resource acquisition is received from a cache controller (not shown in FIG. 1) of the cache. In sending a negative-acknowledgement to the push-based prefetcher, the cache prohibits the push-based prefetcher from sending the prefetch data to the cache. In some implementations, the push-based prefetcher is configured to, in response to receiving a negative-acknowledgement of resource acquisition from the cache, drop the prefetch request. In some implementations, dropping the prefetch request includes releasing the acquired data by the push-based prefetcher. For example, in the system 100 of FIG. 1, the push-based prefetcher 110 initiates a prefetch of data to the L3 cache 106a by sending a resource acquisition request to the L3 cache 106a. In such an example, the push-based prefetcher 110 receives a negative-acknowledgement of resource acquisition from the L3 cache 106a and, in response to receiving the negative-acknowledgement of resource acquisition, drop the prefetch.

In some implementations, the push-based prefetcher is configured to drop the prefetch only in response to receiving a negative-acknowledgement of resource acquisition. In such an implementation, the push-based prefetcher waits until a response to the resource acquisition request is received before either sending the acquired data or dropping the prefetch. That is, the push-based prefetcher drops the prefetch upon expiration of a predefined period of time. In such implementations, a response might not be received for a significant amount of time, if at all, and could thereby waste computing resources that could instead be used for other prefetch requests.

In other implementations, the push-based prefetcher waits for a response only for the amount of time required to acquire the data for prefetching. In such implementations, the push-based prefetcher is configured to, responsive to acquiring the data from the data source, determine whether an acknowledgment of the resource acquisition in response to the request has been received including a tag. If an acknowledgment of resource acquisition has been received including a tag, the push-based prefetcher sends the acquired data and the tag to a data target in the cache of the first level of the memory hierarchy. If an acknowledgement of the resource acquisition request has not been received by the time the data has been acquired by the prefetcher, then the push-based prefetcher drops the prefetch, independent of whether a negative-acknowledgement has been received. In waiting for a response to the resource acquisition request only for the amount of time required to acquire the data for prefetching the push-based prefetcher can prevent long wait times that waste resources.

In such implementations where the push-based prefetcher drops the prefetch before receiving a response from the cache, the push-based prefetcher can receive a response to the resource acquisition request after already dropping the prefetch. In such an example, the push-based prefetcher ignores the response from the cache. In such an example, where the cache controller sends an acknowledgement of resource acquisition after the prefetch has already been dropped by the push-based prefetcher, the cache has allocated resources (such as an MSHR) for a prefetch request for data that will not be received (as the prefetcher has dropped the prefetch). In such an example, the cache, or cache controller of the cache, is configured to wait for the prefetch data for a predetermined amount of time before releasing the allocated resources. Releasing the allocated resources may include de-allocating, by the cache controller, the MSHR when the predetermined amount of time elapses. In some implementations, the cache, or cache controller of the cache, is configured to keep a timestamp associated with an MSHR ID included within the response sent to the push-based prefetcher.

For further explanation, FIG. 2 sets forth a block diagram of another exemplary system 200 configured for pushed prefetching according to implementations of the present disclosure. The example system 200 of FIG. 2 includes a core complex 201 and memory 212 which is connected to the core complex 201 through a bus or interconnect (not shown in FIG. 2). The example core complex 201 includes multiple processor cores 202, multiple L2 caches 204, an L3 cache 206, a push-based prefetcher 210, and a memory directory 214. In some implementations, the example core complex 201 also includes other computer components, hardware, software, firmware, and the like not shown here. In some implementations, for example, each of the cores 202 includes a separate L1 cache (not shown in FIG. 2). In some implementations, the L3 cache 206 is shared by the multiple cores 202 of the core complex 201. The example caches (L1 caches, L2 caches, and L3 cache) of FIG. 2 are configured in a memory hierarchy with multiple levels. In such a memory hierarchy, each type of cache is on a different memory level. For example, in the system 200 of FIG. 2, the L1 caches (not shown in FIG. 2) within the cores 202 are at a highest level of the memory hierarchy, the L2 caches 204 are at a next lower level of the memory hierarchy, and the L3 cache is at a next lower level of the cache hierarchy relative to the L2 caches. Readers of skill will understand that the example core complex of system 200 can include additional caches, at additional levels within the memory hierarchy, that are not shown in FIG. 2. In some implementations, the example memory 212 is at a level within the memory hierarchy that is lower than the levels of each of the caches within the core complex. In some implementations, the memory 212 includes dynamic random access memory (DRAM).

In the example system 200 of FIG. 2, the example push-based prefetcher 210 is located within the core complex, such as by the L3 cache 206. In some implementations, the push-based prefetcher 210 is configured to monitor memory traffic between multiple caches of a first level of the memory hierarchy and a second, lower level of a memory hierarchy. Here, those skilled in the art will understand that the term ‘the first level’ of the memory hierarchy is not limited to L1 caches or to the highest level of the memory hierarchy but can be any one of the multiple levels of the memory hierarchy. Similarly, the term ‘a second, lower level’ of the memory hierarchy is not limited to L2 caches or to the second highest level of the memory hierarchy. In the example system 200 of FIG. 2, the multiple caches of the ‘first level’ of the memory hierarchy at which the push-based prefetcher 210 monitors memory traffic are the L2 caches 204, and the ‘second, lower level’ of the memory hierarchy is the L3 cache 206. In some implementations, monitoring memory traffic between multiple caches of a first level of the memory hierarchy and a second, lower level of a memory hierarchy is carried out by the push-based prefetcher 210 monitoring, at the memory directory 214, the memory traffic passing between each of the L2 caches 204 and the L3 cache 206.

In some implementations, the push-based prefetcher 210 is also configured to, based on the monitoring of the memory traffic, initiate a prefetch of data to a cache of the first level of the memory hierarchy. In some implementations, initiating a prefetch of data to a cache of the first level of the memory hierarchy is carried out by the push-based prefetcher 210 requesting, in a prefetch request, to send data to the cache of the first level of the memory hierarchy. In the example system 200 of FIG. 2, the push-based prefetcher 210 initiates a prefetch of data to an L2 cache of the multiple L2 caches 204 based on monitoring traffic between the L2 caches 204 and the L3 cache 206.

In some implementations, initiating a prefetch of data to a cache of the first level of the memory hierarchy includes sending a resource acquisition request to the cache. In some implementations, the resource acquisition request is sent by the push-based prefetcher to the cache of the first level and includes a request to send data to the cache. In some implementations, in initiating a prefetch of data to a cache of the first level of the memory hierarchy, the push-based prefetcher receives, based on the resource acquisition request, an acknowledgement of resource acquisition including a tag. In some implementations, the acknowledgement of resource acquisition is received by the push-based prefetcher from the cache in response to sending the resource acquisition request to the cache. In some implementations, the acknowledgement of resource acquisition is received from a cache controller (not shown in FIG. 2) of the cache. The tag included within the acknowledgement of resource acquisition can include an ID of a MSHR within an MSHR array. In sending a tag with an acknowledgement to the push-based prefetcher, the cache is indicating that there are available resources within the cache for receiving the prefetch data, as well as identifying which MSHR the cache has allocated for the prefetch request. Continuing with the above example, in the system 200 of FIG. 2, the push-based prefetcher 210 initiates the prefetch of data to the L2 cache by sending a resource acquisition request to the L2 cache. In such an example, the push-based prefetcher 210 receives an acknowledgement of resource acquisition from the L2 cache, the acknowledgement including a tag indicating a MSHR ID of a MSHR array included within the L2 cache.

In some implementations, initiating, by the push-based prefetcher 210, a prefetch of data to a cache of the first level of the memory hierarchy also includes acquiring data from a data source in the memory hierarchy. Acquiring data from a data source in the memory hierarchy is carried out by the push-based prefetcher determining which data source in the memory hierarchy to retrieve the data to prefetch to the cache of the first level, and subsequently retrieving such data from the determined data source. Continuing with the above example, in the system 200 of FIG. 2, the push-based prefetcher 210 acquires data from the L3 cache 206 by determining the data source from which to retrieve the data as being the L3 cache 206, and subsequently retrieving such data from the L3 cache 206. In some implementations, acquiring the data from the data source occurs in parallel with sending the resource acquisition request.

In some implementations, acquiring data from a data source in the memory hierarchy includes referencing a memory directory 214. In the system 200 of FIG. 2, the example memory directory 214 is included within the core complex 201 and is coupled to the push-based prefetcher 210. In some implementations, the example memory directory 214 is configured to monitor all the memory traffic moving between each of the caches of the core complex and the memory 212 and is also configured to keep track of the data currently residing on each level of the memory hierarchy, including the memory 212 and each cache of the core complex 201. In some implementations, the memory directory 214 of example system 200 is a shadow tag directory. In acquiring data from a data source in the memory hierarchy, the push-based prefetcher 210 can reference the memory directory 214 to determine the data source in the memory hierarchy that includes the data to be acquired. In some implementations, the data source is determined, by logic within the push-based prefetcher, to be within the L3 cache 206, within another L2 cache, or within the L2 cache of the first level of the memory hierarchy. If the data source is determined to be the cache of the first level, where the cache already has the data, the push-based prefetcher determines not to prefetch or determines to drop the prefetch. If the data source is determined to be the L3 cache 206, the push-based prefetcher acquires the data from that data source. If the data source is determined to be within an L2 cache other than the L2 cache for which the prefetch is directed towards, the push-based prefetcher acquires the data from that data source.

In some implementations, the push-based prefetcher 210, in prefetching data to a cache of the first level of the memory hierarchy, is configured to send the acquired data and the tag to a data target in the cache of the first level of the memory hierarchy. Sending the acquired data and the tag to a data target in the cache of the first level of the memory hierarchy is carried out by the push-based prefetcher 210 only after receiving the acknowledgement from the cache, since the cache must first allocate resources (a specific MSHR) for receiving the prefetch data from the push-based prefetcher. Continuing with the above example, in the system 200 of FIG. 2, the push-based prefetcher 210, only after receiving an acknowledgement including a tag from the L2 cache, sends the acquired data and the received tag to a data target in the L2 cache, thereby completing the prefetch of data to the cache of the first level of the memory hierarchy.

In some implementations, in initiating a prefetch of data to a cache of the first level of the memory hierarchy, the push-based prefetcher 210 receives, based on the resource acquisition request, a negative-acknowledgement of resource acquisition. The negative-acknowledgement of resource acquisition is received by the push-based prefetcher from the cache in response to sending the resource acquisition request to the cache. In some implementations, the negative-acknowledgement of resource acquisition is received from a cache controller (not shown in FIG. 2) of the cache. In sending a negative-acknowledgement to the push-based prefetcher, the cache prohibits the push-based prefetcher from sending the prefetch data to the cache. In some implementations, the push-based prefetcher is configured to, in response to receiving a negative-acknowledgement of resource acquisition from the cache, drop the prefetch request. In some implementations, dropping the prefetch request includes releasing the acquired data by the push-based prefetcher. For example, in the system 200 of FIG. 2, the push-based prefetcher 210 initiates a prefetch of data to an L2 cache by sending a resource acquisition request to the L2 cache. In such an example, the push-based prefetcher 210 receives a negative-acknowledgement of resource acquisition from the L2 cache and, in response to receiving the negative-acknowledgement of resource acquisition, drop the prefetch.

In some implementations, the push-based prefetcher is configured to drop the prefetch only in response to receiving a negative-acknowledgement of resource acquisition. In such an implementation, the push-based prefetcher waits until a response to the resource acquisition request is received before either sending the acquired data or dropping the prefetch. In such implementations, a response might not be received for a significant amount of time, if at all, and could thereby waste computing resources that could instead be used for other prefetch requests.

In other implementations, the push-based prefetcher waits for a response only for the amount of time required to acquire the data for prefetching. In such implementations, the push-based prefetcher is configured to, responsive to acquiring the data from the data source, determine whether an acknowledgment of the resource acquisition in response to the request has been received including a tag. If an acknowledgment of resource acquisition has been received including a tag, the push-based prefetcher sends the acquired data and the tag to a data target in the cache of the first level of the memory hierarchy. If an acknowledgement of the resource acquisition request has not been received by the time the data has been acquired, the push-based prefetcher drops the prefetch, independent of whether a negative-acknowledgement has been received. In waiting for a response to the resource acquisition request only for the amount of time required to acquire the data for prefetching, the push-based prefetcher can prevent long wait times that waste resources.

In such implementations where the push-based prefetcher drops the prefetch before receiving a response from the cache, the push-based prefetcher can receive a response to the resource acquisition request after already dropping the prefetch. In such an example, the push-based prefetcher ignores the response from the cache. In such an example, where the cache controller sends an acknowledgement of resource acquisition after the prefetch has already been dropped by the push-based prefetcher, the cache has allocated resources (such as an MSHR) for a prefetch request for data that will not be received. In such an example, the cache, or cache controller of the cache, is configured to wait for the prefetch data for a predetermined amount of time before releasing the allocated resources. In some implementations, the cache, or cache controller of the cache, is configured to keep a timestamp associated with an MSHR ID included within the response sent to the push-based prefetcher.

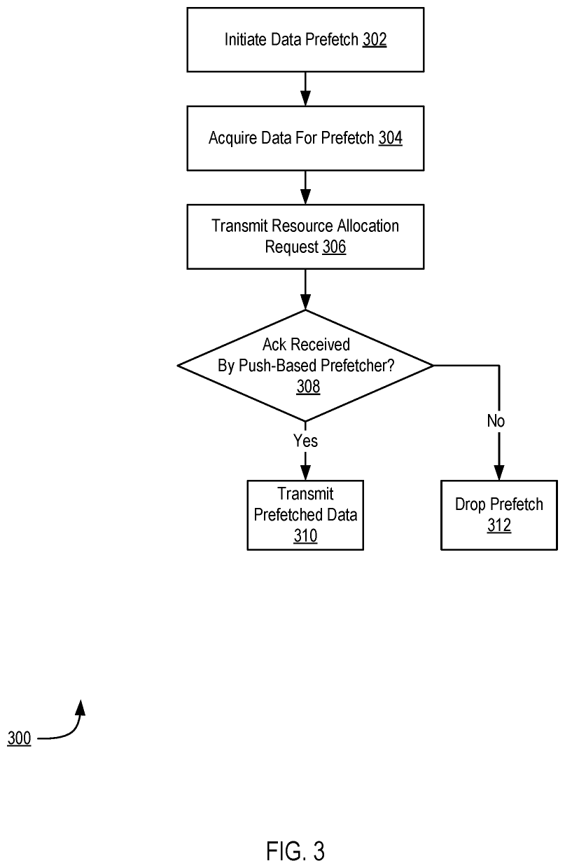

For further explanation, FIG. 3 sets forth a flow chart illustrating a method of push-based prefetching according to aspects of the present disclosure. The method 300 of FIG. 3 includes initiating 302 a prefetch of data to a cache of a first level of a memory hierarchy. The prefetch is initiated based on monitoring of memory traffic between two levels of the memory hierarchy. In some implementations, initiating a prefetch to a cache of the first level of the memory hierarchy is carried out by a push-based prefetcher requesting, in a prefetch request, to send data to the cache of the first level of the memory hierarchy. For example, a push-based prefetcher can initiate a prefetch of data to an L3 cache (e.g., 106a of FIG. 1) based on monitoring traffic between the L3 caches and a shared memory (e.g., 112 of FIG. 1). The prefetch request may be sent through an interconnect (e.g. 108 of FIG. 1) to L3 cache 106.

The method of FIG. 3 continues by acquiring 304 data from a data source for the prefetch and transmitting 306 a resource acquisition request to the cache. The resource acquisition request is sent by the push-based prefetcher to the cache of the first level and includes a request to send data to the cache.

The method of FIG. 3. also includes determining 308 whether an acknowledgment has been received by the push-based prefetcher. If such an acknowledgement has not been received, the push-based prefetcher drops 312 (or ceases) the prefetch operation. If the push-based prefetcher receives an acknowledgement of resource acquisition, the push-based prefetcher then transmits 31—the acquired data to the cache of the first level.

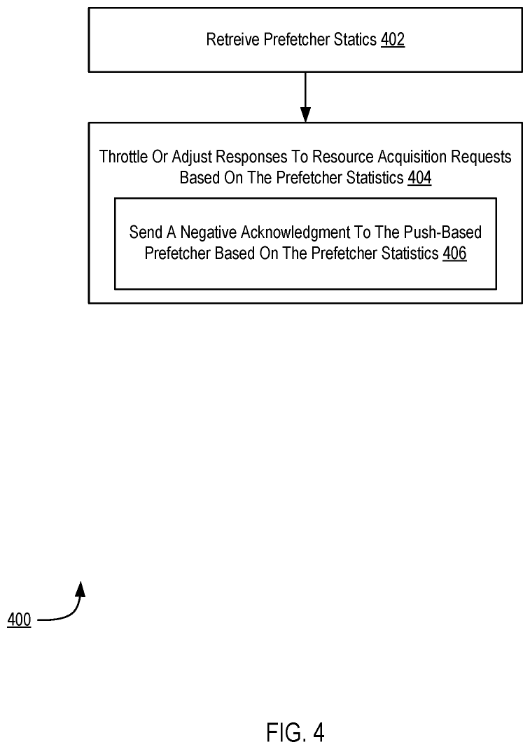

For further explanation, FIG. 4 sets forth a flowchart illustrating an example method 400 of pushed prefetch throttling according to some implementations of the present disclosure. The method 400 of FIG. 4 includes retrieving 402 prefetcher statistics. In some implementations, prefetcher statistics include statistics based on one or more performance metrics of the push-based prefetcher, such as prefetcher coverage, prefetcher accuracy, and prefetcher timeliness. In some implementations, retrieving 402 prefetcher statistics is carried out by logic within a cache controller (not shown in FIG. 4) of one of the core complex's caches by tracking one or more performance metrics of the push-based prefetcher or by receiving prefetcher statistics for the push-based prefetcher from another computing element of the system.

The method of FIG. 4 also includes throttling or adjusting 404 responses to resource acquisition requests based on the prefetcher statistics. Throttling or adjusting 404 responses to resource acquisition requests based on the prefetcher statistics is carried out by logic within a cache controller of a cache in response to the cache receiving a resource acquisition request from the push-based prefetcher requesting to send prefetched data to the cache. In some implementations, throttling or adjusting 404 responses to resource acquisition requests is carried out independent of whether there are available resources in the cache for receiving the requesting prefetched data from the push-based prefetcher. For example, a cache can determine or assess that resources are available for receiving the requesting prefetched data from the push-based prefetcher but still respond to not receive the data based on the prefetcher statistics indicating one or more performance metrics of the push-based prefetcher falling below a threshold.

The method of FIG. 4 also includes, as part of throttling or adjusting 404 responses to resource acquisition requests based on a the prefetcher statistics, sending 406 a negative acknowledgment to the push-based prefetcher based on the prefetcher statistics. Sending 406 a negative acknowledgment to the push-based prefetcher based on the prefetcher statistics is carried out by the cache controller (or logic included therein) sending a negative acknowledgment to the push-based prefetcher based on the prefetcher statistics independent of whether there are available resources in the cache for receiving the requesting prefetched data from the push-based prefetcher. For example, in the system of FIG. 1, the L3 cache 106a receives a resource acquisition request from the push-based prefetcher 110 requesting to send data to the L3 cache 106a. In the above example system 100 of FIG. 1, without throttling, the L3 cache 106a would send an acknowledgement to the push-based prefetcher 110 in response to assessing that resources are available for receiving the requesting data from the push-based prefetcher 110, and send a negative acknowledgement to the push-based prefetcher 110 based only when there are not available resources for receiving the requesting data from the push-based prefetcher 110. However, in the above example system 100 of FIG. 1, with throttling or adjusting 404, the L3 cache 106a sends a negative acknowledgement to the push-based prefetcher 110 based on the prefetcher statistics even when resources are available for receiving the requesting data from the push-based prefetcher 110. In such an example, a cache controller (not shown in FIG. 1) of the L3 cache 106a sends a negative acknowledgement to the push-based prefetcher 110, even if resources are available in the cache, based on the prefetcher statistics indicating that one or more performance metrics of the push-based prefetcher 110 have fallen below a predetermined acceptable threshold.

In throttling or adjusting 404 responses to resource acquisition requests based on the prefetcher statistics, the cache controller can deny resource acquisition requests from the push-based prefetcher based on one or more of prefetcher coverage, prefetcher accuracy, and prefetcher timeliness (or other metrics). Such throttling or adjusting 404 of resource acquisition request responses by the cache can reduce unnecessary use of system resources and increase system performance and efficiency.

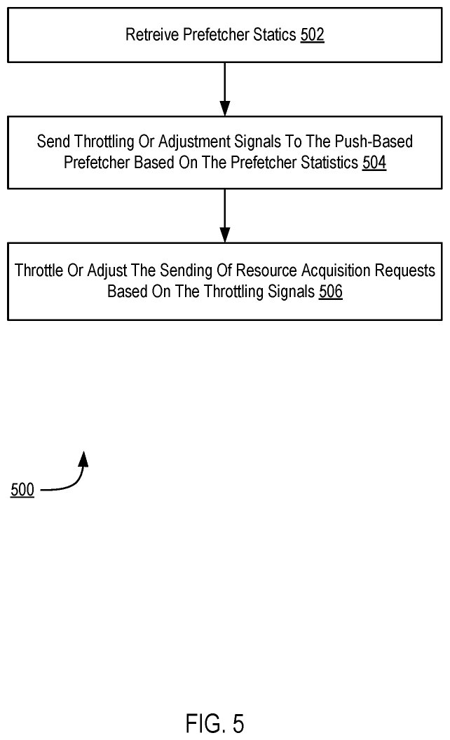

For further explanation, FIG. 5 sets forth a flowchart illustrating an example method 500 of pushed prefetch throttling according to some implementations of the present disclosure. The method 500 of FIG. 5 includes retrieving 502 prefetcher statistics. In some implementations, prefetcher statistics include statistics based on one or more performance metrics of the push-based prefetcher, such as prefetcher coverage, prefetcher accuracy, and prefetcher timeliness. In some implementations, retrieving 502 prefetcher statistics is carried out by logic within a cache controller (not shown in FIG. 5) of one of the core complex's caches by tracking one or more performance metrics of the push-based prefetcher or by receiving prefetcher statistics for the push-based prefetcher from another computing element of the system and, responsive to those statistics operating in certain manners.

The method of FIG. 5 also includes sending 504 throttling signals to the push-based prefetcher based on the prefetcher statistics. Sending 504 throttling signals to the push-based prefetcher based on the prefetcher statistics is carried out by logic within a cache controller of a cache configured to receive resource acquisition requests from the push-based prefetcher. In the example system 100 of FIG. 1, such a cache controller is included within L3 caches 106a and 106b, which are configured to receive resource acquisition requests from the push-based prefetcher 110. In the example system 200 of FIG. 2, such a cache controller is included within the L2 caches 204, which are configured to receive resource acquisition requests from the push-based prefetcher 210. In some implementations, throttling signals include instructions for the push-based prefetcher to throttle the sending of resource acquisition requests and are based on the determined prefetcher statistics. For example, a cache or cache controller can send throttling signals to the push-based prefetcher based on the prefetcher statistics indicating one or more performance metrics of the push-based prefetcher falling below a threshold. In some implementations, throttling signals sent to the push-based prefetcher are included within a response to a resource acquisition request received from the push-based prefetcher.

The method of FIG. 5 also includes adjusting or throttling 506 the sending of resource acquisition requests based on the throttling signals. Adjusting or throttling 506 the sending of resource acquisition requests based on the throttling signals is carried out by the push-based prefetcher limiting the sending of resource acquisition requests based on the throttling signals received from the cache. In one example implementation of the method 500 of FIG. 5, and in the example system of FIG. 1, the L3 cache 106a receives a resource acquisition request from the push-based prefetcher 110 requesting to send data to the L3 cache 106a. In such an example, the L3 cache 106a includes throttling signals within the response to the push-based prefetcher 110 based on the prefetcher statistics indicating that one or more performance metrics of the push-based prefetcher 110 have fallen below a predetermined acceptable threshold. Continuing with the example implementation, the push-based prefetcher 110 throttles or adjusts the sending of subsequent resource acquisition requests based on the throttling signals received from the L3 cache 106a. In some implementations, the throttling signals indicate a level of throttling or include a frequency of resource acquisition requests allowed.

In adjusting or throttling 506 the sending of resource acquisition requests based on the throttling signals, the cache controller can adjust the aggressiveness of the push-based prefetcher by controlling the amount of resource acquisition requests to be sent from the push-based prefetcher based on one or more of determined prefetcher coverage, prefetcher accuracy, and prefetcher timeliness. Such throttling 506 can reduce unnecessary use of system resources and increase system performance and efficiency.

In view of the explanations set forth above, persons of ordinary skill in the art will recognize that pushed prefetching according to the various implementations of the present disclosure allows for improved prefetcher timeliness. In conventional methods of prefetching, using a pull-based prefetcher, an issued prefetch request targeting a particular level of the memory hierarchy must be propagated down the levels of each cache, starting from the particular level at which the prefetch was issued down to the memory level of the data source before then prefetching the data all the way back up to the particular level. In some implementations, pushed prefetching in accordance with the present disclosure includes a push-based prefetcher that is instead configured to issue the prefetch directly from the memory level of the data source.

In view of the explanations set forth above, persons of ordinary skill in the art will recognize that pushed prefetching according to the various implementations of the present disclosure also allows for improved prefetcher coverage. According to some implementations of the present disclosure, the push-based prefetcher is configured to push prefetch data to a memory level that is higher than the memory level from which the prefetch request was issued, which is in contrast to conventional methods of prefetching, using a pull-based prefetcher, which can only pull data up to the memory level which issued the prefetch request. Readers will recognize that pushed prefetching according to the various implementations of the present disclosure also allows for improved prefetcher training by configuring the prefetcher to monitor additional memory traffic compared with a conventional pull-based prefetcher.

It will be understood from the foregoing description that modifications and changes can be made in various implementations of the present disclosure. The descriptions in this specification are for purposes of illustration only and are not to be construed in a limiting sense. The scope of the present disclosure is limited only by the language of the following claims.

What is claimed is:

1. An apparatus comprising:
a memory configured as a memory hierarchy with multiple levels, the memory comprising a first memory having a first level in the memory hierarchy and a second memory having a second level in the memory hierarchy, the second level being lower than the first level in the memory hierarchy; and
a push-based prefetcher in communication with the memory, the push-based prefetcher comprising logic to:
monitor memory traffic between the first memory and the second memory; and
based on the monitoring, push a prefetch of data to the first memory from the second memory.

2. The apparatus of claim 1, further comprising:
a plurality of cores, each core having a cache, wherein the first memory comprises one of the caches, the cores are in communication with a shared memory, and the shared memory comprises the second memory.

3. The apparatus of claim 1, further comprising a plurality of cores, each core having a plurality of caches, each cache of a core at a different level of the memory hierarchy, wherein one cache of a core comprises the first memory and a second cache of the core comprises the second memory.

4. The apparatus of claim 2, wherein the plurality of cores are configured in one or more core complexes.

5. The apparatus of claim 4, wherein the push-based prefetcher is separate from the plurality of core complexes.

6. The apparatus of claim 1, wherein the push-based prefetcher further comprises logic to send data acquired from the second memory to the first memory in response to an acknowledgement received from the first memory.

7. The apparatus of claim 6, wherein:
the second memory comprises logic to send a resource acquisition request to the first memory; and
the first memory comprises logic to send the acknowledgment to the second memory in response to the resource acquisition request.

8. The apparatus of claim 6, wherein the push-based prefetcher further comprises logic to:
send a resource acquisition request to the first memory;
receive, based on the resource acquisition request, an acknowledgement of resource acquisition;
acquire data from a data source in the memory hierarchy; and
only after receiving the acknowledgement, send the acquired data to a data target in the first memory.

9. The apparatus of claim 8, wherein sending the resource acquisition request occurs in parallel with acquiring the data from the data source.

10. The apparatus of claim 1, wherein the push-based prefetcher further comprises logic to drop a resource acquisition request responsive to receiving a negative acknowledgement.

11. The apparatus of claim 1, wherein the push-based prefetcher further comprises logic to drop a resource acquisition request responsive to expiration of a predefined period of time.

12. The apparatus of claim 11, wherein the push-based prefetcher further comprises logic to:
send a resource acquisition request to the first memory;
receive, based on the resource acquisition request, a negative-acknowledgement of resource acquisition; and
only after receiving the negative-acknowledgement, drop the prefetch responsive to the negative-acknowledgement.

13. The apparatus of claim 1, wherein the push-based prefetcher further comprises logic to:
send a resource acquisition request to the first memory;
acquire data from a data source in the memory hierarchy; and
responsive to acquiring the data from the data source:
if an acknowledgment of the resource acquisition request has been received, send the acquired data to a data target in the first memory; and
if an acknowledgement of the resource acquisition request has not been received, independent of receiving a negative-acknowledgement, drop the prefetch.

14. The apparatus of claim 1, wherein the push-based prefetcher further comprises logic to:
acquire data from a source based on a memory directory for the data when the source of the data is at a lower level than the first memory.

15. The apparatus of claim 1, further comprising a plurality of cores, each core comprising a cache in communications with a shared memory, wherein the cache comprises the first memory and the shared memory comprises the second memory and the push-based prefetcher further comprises logic to:
acquire data from a source based on a memory directory for the data when the source of the data is at any level within another core separate from the core including the first memory.

16. The apparatus of claim 1, wherein the push-based prefetcher further comprises logic to:
drop prefetch request for data based on a memory directory for the data indicating that the data is already at first memory.

17. The apparatus of claim 1, further comprising:
a plurality of cores, each core comprising a cache in communications with a shared memory, wherein the first memory comprises one of the caches and the shared memory comprises the second memory; and
a cache controller for the first memory, the cache controller comprising logic configured to throttle responses to resource acquisition requests sent from the push-based prefetcher based on prefetcher statistics.

18. The apparatus of claim 17, wherein the cache controller further comprises logic to send a negative-acknowledgement to the push-based prefetcher based on the prefetcher statistics independent of availability of resources for the push-based prefetcher.

19. The apparatus of claim 1, further comprising:
a plurality of cores, each core comprising a cache in communications with a shared memory, wherein the first memory comprises one of the caches and the shared memory comprises the second memory; and
a cache controller of the first memory, the cache controller comprising logic configured to send, to the push-based prefetcher, throttling signals based on prefetcher statistics.

20. The apparatus of claim 19, wherein the push-based prefetcher further comprises logic to throttle the sending of resource acquisition requests based on the throttling signals.
